(19) United States
(12) Patent Application Publication
(10) Pub. No.: US 2025/0074372 A1
(43) Pub. Date: Mar. 6, 2025

(54) BRAKE CONTROL DEVICE FOR VEHICLE

(71) Applicant: SUBARU CORPORATION, Tokyo (JP)

(72) Inventor: Harunobu HORIGUCHI, Tokyo (JP)

(73) Assignee: SUBARU CORPORATION, Tokyo (JP)

(21) Appl. No.: 18/772,425

(22) Filed: Jul. 15, 2024

(30) Foreign Application Priority Data
Aug. 28, 2023 (JP) 2023-137920

(51) Int. Cl. B60T 8/172

(52) U.S. Cl. CPC B60T 8/172; B60T 2210/12

(57) ABSTRACT

A brake control device for a vehicle includes a drive force controller, a parking brake system, and a control unit at least including a parking brake state determiner that determines a state of the parking brake system and a road surface μ estimator that estimates a friction coefficient of a road surface. The control unit performs drive control of front wheels and rear wheels of the vehicle individually based on the parking brake system's state and the friction coefficient. The parking brake system maintains a parking/stopping state of the vehicle. When determining the parking brake system is in a sticking state, the drive force controller limits driving of the front wheels and drives the rear wheels when the estimated friction coefficient is smaller than a predetermined threshold, and drives only the front wheels when the estimated friction coefficient is larger than or equal to the predetermined threshold.

### CROSS-REFERENCE TO RELATED APPLICATION

The present application claims priority from Japanese Patent Application No. 2023-137920 filed on Aug. 28, 2023, the entire contents of which are hereby incorporated by reference.

### BACKGROUND

The disclosure relates to a brake control device for a vehicle, such as an automobile, and more particularly, to a control operation for a parking brake system.

Typically, a vehicle, such as an automobile, is equipped with a parking brake system for maintaining the parking/stopping state of the vehicle. If this type of parking brake system is left for long hours while being activated under a cryogenic temperature environment in a cold region, for example, a portion between a friction applying member (such as a brake shoe or a brake pad) and a friction applied member (such as a brake drum or a brake rotor) may be frozen and stuck. If a parking brake system is stuck in this manner, it may be difficult to cancel its activation state.

Various technologies for clearing such a sticking state of known parking brake systems are proposed. An example of such technologies is disclosed in Japanese Unexamined Patent Application Publication (JP-A) No. 2010-241271.

As an example of the technologies for clearing the sticking state of a parking brake system caused by the freezing, for example, a brake control device for a vehicle disclosed in JP-A No. 2010-241271, for example, generates a braking force larger than that under the regular situation.

As another example of the technologies for clearing the sticking state of a parking brake system for a vehicle, a brake control device disclosed in JP-A No. 2014-226975, for example, performs drive control to increase a drive torque when the vehicle starts to move.

When a parking brake system has recovered from the sticking state, the acceleration suddenly starts to rise. A brake torque is thus applied to suppress a sudden rise in the acceleration. At this time, however, there may be a response delay for the deceleration implemented by the brake torque. The brake control device disclosed in JP-A No. 2014-226975, for example, can provide a good responsiveness to such a brake torque so as to suppress a sudden rise in the acceleration.

### SUMMARY

An aspect of the disclosure provides a brake control device for a vehicle. The brake control device includes a drive force controller, a parking brake system, and a control unit. The control unit at least includes a parking brake state determiner and a road surface μ estimator. The drive force controller is configured to perform drive control of front wheels and rear wheels of the vehicle individually. The parking brake system is configured to maintain a parking/stopping state of the vehicle. The parking brake state determiner is configured to determine a state of the parking brake system. The road surface μ estimator is configured to estimate a friction coefficient of a road surface. The control unit is configured to cause the drive force controller to perform drive control of the front wheels and the rear wheels individually based on a determination result of the parking brake state determiner and an estimation result of the road surface μ estimator. The drive force controller is configured to, when the control unit has determined that the parking brake system is in a sticking state, perform drive control to limit driving of the front wheels and to drive the rear wheels when the estimated friction coefficient of the road surface is smaller than a predetermined threshold, and perform drive control to drive only the front wheels when the estimated friction coefficient of the road surface is larger than or equal to the predetermined threshold.

An aspect of the disclosure provides a brake control device for a vehicle. The brake control device includes a parking brake system and circuitry. The parking brake system is configured to maintain a parking/stopping state of the vehicle. The circuitry is configured to perform drive control of front wheels and rear wheels of the vehicle individually. The circuitry is configured to determine a state of the parking brake system. The circuitry is configured to estimate a friction coefficient of a road surface. The circuitry is configured to perform drive control of the front wheels and the rear wheels individually based on the determined state of the parking brake system and the estimated friction coefficient of the road surface. The circuitry is configured to, when determining that the parking brake system is in a sticking state: perform drive control to limit driving of the front wheels and to drive the rear when the estimated friction coefficient of the road surface is smaller than a predetermined threshold; and perform drive control to drive only the front wheels when the estimated friction coefficient of the road surface is larger than or equal to the predetermined threshold.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic view illustrating the configuration of a vehicle which loads a brake control device of an embodiment of the disclosure;

FIG. 2 is a block diagram illustrating the schematic configuration of a vehicle driving control apparatus including the brake control device of the embodiment of the disclosure;

FIG. 3 is a flowchart illustrating an operation of the vehicle driving control apparatus including the brake control device of the embodiment of the disclosure, and more particularly, a control operation of the vehicle driving control apparatus for a parking brake system; and

FIG. 4 is a flowchart illustrating a subsequence of sticking recovery processing in step S8 in FIG. 3.

### DETAILED DESCRIPTION

Even with the use of known brake control devices, such as those disclosed in JP-A No. 2010-241271 and JP-A No. 2014-226975, it is not always successful to clear the sticking state of a parking brake system.

Additionally, the brake control device disclosed in JP-A No. 2014-226975, for example, performs prefill control to decrease the distance between a friction applying member and a friction applied member. The technology disclosed in this publication thus demands high-precision, complicated control.

Typically, a parking brake system for a vehicle, such as for a regular four-wheel automobile, operates for the two rear wheels. In the case of known four-wheel vehicles, such as four-wheel automobiles, vehicles using a front-wheel drive system for driving the two front wheels, as well as vehicles using an all-wheel drive system for driving all the four wheels including the front and rear wheels, are usually popular.

In a vehicle using the all-wheel drive system or the front-wheel drive system, if a parking brake system for the vehicle is stuck and if the friction coefficient of the road surface (road surface μ) is very low due to an icy road surface, for example, when a drive force is applied to the front wheels, the vehicle may start running although the rear wheels are in a locking state due to the sticking of the parking brake system.

If the vehicle starts running while the rear wheels are in the locking state and would not rotate, it is unable to stably drive.

In the case of a vehicle using the all-wheel drive system, a drive source tries to transmit a drive force to the rear wheels as well as to the front wheels. This imposes an excessive burden on the drive source because the rear wheels are in the locking state and would not rotate.

When the parking brake system has recovered from the sticking state, a drive force is suddenly applied to the rear wheels in the locking state, which may cause an abrupt increase in the acceleration. This may make the driving of the vehicle unstable.

It is thus desirable to perform control to suppress a sudden increase in the acceleration and to implement stable driving.

Hence, it is desirable to provide a brake control device for a vehicle, such as an automobile, which can perform control to enable a parking brake system for the vehicle to easily recover from a sticking state caused by the freezing, for example, while regulating an excessive burden on a drive source of the vehicle and also to secure the stable driving of the vehicle.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

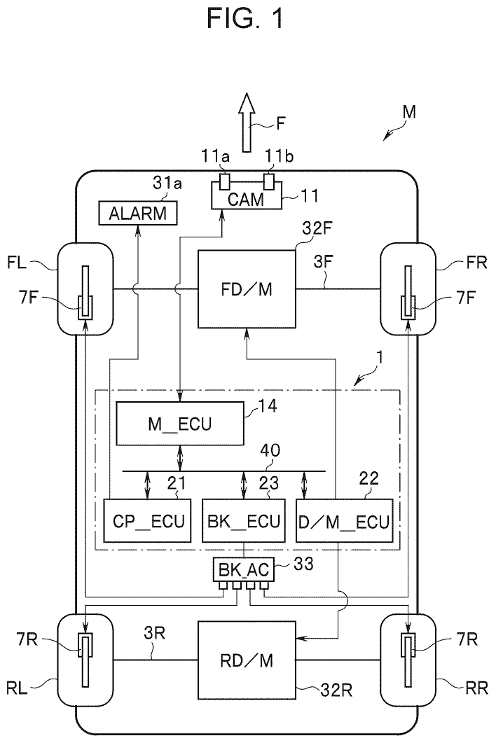

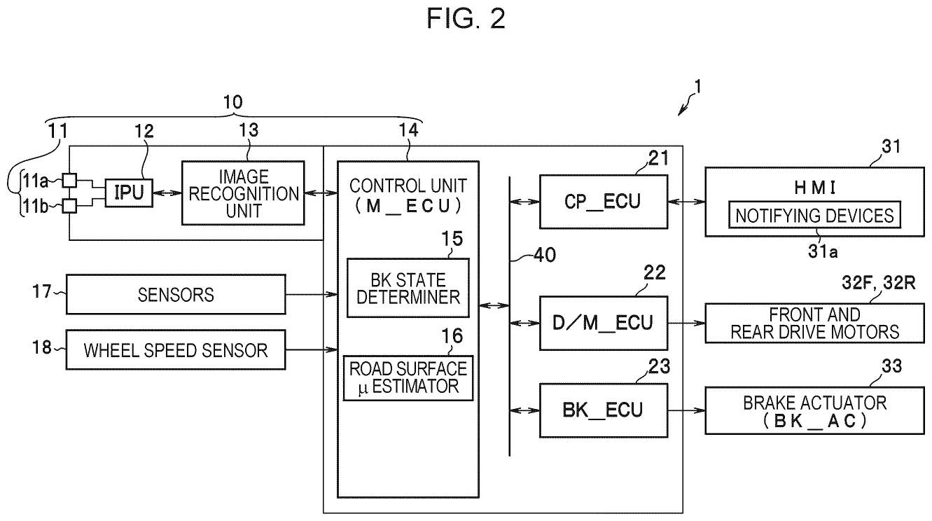

The schematic configuration of a vehicle which loads a brake control device according to the embodiment of the disclosure and that of a vehicle driving control apparatus including the brake control device will be described below with reference to FIGS. 1 and 2. FIG. 1 is a schematic view illustrating the configuration of a vehicle M which loads the brake control device of the embodiment of the disclosure. FIG. 2 is a block diagram illustrating the schematic configuration of a vehicle driving control apparatus 1 including the brake control device of the embodiment of the disclosure.

The basic configuration of the vehicle M illustrated in FIG. 1 and that of the vehicle driving control apparatus 1 illustrated in FIG. 2 are similar to those of the same type of known vehicle and the same type of known vehicle driving control apparatus. In the following description and illustration in FIGS. 1 and 2, a detailed explanation and illustration of typical components of the same type of known vehicle and the same type of known vehicle driving control apparatus is omitted. Only major components related to the disclosure are illustrated in FIGS. 1 and 2 and will be explained below.

The vehicle driving control apparatus 1 including the brake control device of the embodiment includes a camera unit 10 (see FIG. 2), which is an in-vehicle camera device. The camera unit 10 includes a stereo camera 11 fixed to the top center of the front side of the compartment of the vehicle M (see FIG. 1) which loads the vehicle driving control apparatus 1.

In FIG. 1, the arrow F indicates the traveling direction (forward direction) of the vehicle M. As illustrated in FIG. 1, the vehicle M has a front right wheel FR, a front left wheel FL, a rear right wheel RR, and a rear left wheel RF. Hereinafter, the front right wheel FR, front left wheel FL, rear right wheel RR, and rear left wheel RF may simply be called the front wheels FR and FL and the rear wheels RR and RL or the wheels FR, FL, RR, and RF unless it is necessary to individually distinguish them from each other.

As illustrated in FIG. 1, a brake 7F is provided in each of the front wheels FR and FL, while a brake 7R is provided in each of the rear wheels RR and RL.

The brakes 7F and 7R are each constituted by individual members, such as a friction applying member (a brake shoe or a brake pad, for example), a friction applied member (a brake drum or a brake rotor, for example), and an actuator (a brake booster, a master cylinder, a brake fluid pipe, and a wheel cylinder or a brake caliper, for example, none of which are illustrated) for activating the friction applying member. As an example of the configuration of the brakes 7F and 7R, a brake pad, which serves as a friction applying member, and a brake rotor, which serves as a friction applied member, are illustrated in FIG. 1.

It is assumed that a typical known brake is used for the brakes 7F and 7R and a detailed explanation and illustration of the configuration of the brakes 7F and 7R will be omitted.

The brakes 7R used for the rear wheels RR and RL also serve as a parking brake system. The parking brake system is used for maintaining the parking/stopping state of the vehicle M.

It is assumed that an electric parking brake (EPB) system is used as the parking brake system in the vehicle M which loads the vehicle driving control apparatus 1. This type of parking brake system can be activated by turning ON a predetermined parking brake operation switch, for example, and can be deactivated by turning OFF this switch.

An ON signal is generated in response to the parking brake operation switch being turned ON (hereinafter such a signal will be called a parking brake ON signal) and is output to a brake control unit (BK_ECU) 23, which will be discussed later. Upon receiving the parking brake ON signal, the brake control unit 23 performs control to cause a brake actuator 33, which will be discussed later, to drive the brakes 7R provided in the rear wheels RR and RL and as a parking brake system. With this control operation, the brakes 7R can serve as a parking brake system.

As illustrated in FIG. 2, the camera unit 10 includes components, such as a stereo camera 11, an image processing unit (represented as “IPU” in FIG. 2) 12, an image recognition unit 13, and a control unit (represented as “M_ECU” in FIG. 1) 14. The image processing unit 12 and the image recognition unit 13 are not illustrated in FIG. 1 to avoid the complexity of the drawing.

The stereo camera 11 includes two cameras, that is, a main camera 11a and a sub-camera 11b. The main camera 11a and the sub-camera 11b are disposed in the compartment of the vehicle M at horizontally symmetrical positions along the width of the vehicle M, for example, so as to face ahead of the vehicle M (traveling direction indicated by the arrow F in FIG. 1). The main camera 11a and the sub-camera 11b are each constituted by an imaging optical system, an imaging element, such as a CMOS image sensor, and a processing circuit that processes signals, such as imaging signals, for example. The detailed configuration of the main camera 11a and the sub-camera 11b is not illustrated.

With the above-described configuration, by using the main camera 11a and the sub-camera 11b, the stereo camera 11 images the surrounding environment in a predetermined range ahead of the vehicle M at preset synchronizing imaging intervals so as to obtain two pieces of image data captured from two different viewpoints. The stereo camera 11 then generates stereo image data based on the two pieces of image data. The stereo image data corresponds to surrounding environment information representing the surrounding environment during the driving of the vehicle M. The surrounding environment information (image data) generated by the stereo camera 11 is output to the image processing unit 12.

The image processing unit 12 is a component unit or a circuit unit that performs predetermined image processing on the surrounding environment information (image data representing the environment during the driving of the vehicle M) generated by the stereo camera 11. For example, the image processing unit 12 executes processing to detect edges of various objects, such as solid objects and marking lines, included in the image.

The image processing unit 12 also obtains distance information in accordance with the positional disparity of the corresponding edges between the left and right images based on the stereo image data and generates image information including this distance information (hereinafter called distance image information). Information, such as the distance image information, generated by the image processing unit 12 is output to the image recognition unit 13.

Based on the information, such as the distance image information, received from the image processing unit 12, the image recognition unit 13 calculates the curvatures [1/m] of left and right marking lines of a traveling route of the vehicle M and also calculates the width (lane width) between the left and right marking lines. Various known methods can be used to calculate the curvatures and the lane width.

The image recognition unit 13 also performs predetermined pattern matching based on the distance image information generated by the image processing unit 12 so as to recognize objects along the road (guardrails, curbs, and other vehicles around the vehicle M, for example), parking space lines defined by marking lines on the road in a facility, such as a parking lot, solid objects, such as parking blocks that define individual parking spaces, and a gap between the vehicle M and an adjacent vehicle. The image recognition unit 13 also recognizes the condition of the road surface around the vehicle M (hereinafter called the road surface condition), for example.

For each object, the image recognition unit 13 recognizes the type of object, height of the object, width of the object, distance from the vehicle M to the object, velocity of the object, and relative velocity of the object to the vehicle M, for example. The image recognition unit 13 also recognizes the relative distance between objects, such as the lateral distance between a curb at the edge of the road and a marking line nearby.

As the road surface condition, the image recognition unit 13 recognizes, for example, that the road surface is wet with rain or snowmelt. The image recognition unit 13 also recognizes various other conditions, such as the rainfall, snowfall, compacted snow, and icy road surface. These road surface conditions can be estimated based on the luminance difference in the image, for example.

The above-described various items of information recognized by the image recognition unit 13 are output to the control unit 14 as the surrounding environment information. The camera unit 10 including the image recognition unit 13 serves as a surrounding environment recognition device that recognizes the surrounding environment of a vehicle.

The control unit 14 included in the camera unit 10 is a component unit or a circuit unit that controls the camera unit 10 and that also centrally controls the vehicle driving control apparatus 1 including the brake control device of the embodiment.

Various control units, such as a cockpit control unit (CP_ECU) 21, a drive motor control unit (D/M_ECU) 22, and a brake control unit (BK_ECU) 23, are coupled to the control unit 14 via an in-vehicle communication network, such as a controller area network (CAN) 40.

A human machine interface (HMI) 31 disposed near a driver's seat is coupled to the CP_ECU 21. The HMI 31 includes various operation members, various sensing devices, and various notifying devices 31a (represented as “ALARM” in FIG. 1), for example.

Examples of various operation members are a parking brake operation switch for turning ON and OFF the activation of the parking brake system, an operation switch for providing an instruction to execute or stop various drive assist control operations, and a mode changeover switch for switching the driving mode.

Examples of various sensing devices are a steering touch sensor that detects the steering state of a human driver, a driver monitoring system (DMS) that recognizes the face of a human driver and detects his/her eye direction, for example, and an in-vehicle monitor system constituted by an in-vehicle camera, for example, that recognizes the states of occupants including a human driver in the vehicle M.

Examples of various notifying devices 31a are a touchscreen display (visual display device), a sound generating device (audio display device) including a speaker, and a combination meter integrating various instruments.

The CP_ECU 21 is a component unit or a circuit unit that executes the following operation. In response to a control signal from the control unit 14, the CP_ECU 21 suitably supplies various items of information (such as information on various alarms, the execution status of drive assist control, and the surrounding environment of the vehicle M) to the human driver in a predetermine mode, such as a visual or audio display mode, by using the notifying devices 31a of the HMI 31.

The CP_ECU 21 also outputs various items of input information indicated by instruction signals input by the human driver using various operation members included in the HMI 31 to the control unit 14. Examples of the instruction signals are an instruction to turn ON or OFF the parking brake system and an instruction to turn ON or OFF various drive assist control operations.

Drive motors 32F and 32R, which are drive sources of the vehicle M, for example, are coupled to the output side of the D/M_ECU 22. Various sensors (not illustrated), such as an accelerator sensor, are coupled to the input side of the D/M_ECU 22.

As the drive motors, a front drive motor (FD/M) 32F and a rear drive motor (RD/M) 32R are provided. The front drive motor 32F is a drive source that drives the front wheels FR and FL via a front axle 3F. The rear drive motor 32R is a drive source that drives the rear wheels RR and RL via a rear axle 3R.

The D/M_ECU 22 is a component unit or a circuit unit that performs drive control of the front drive motor 32F and the rear drive motor 32R based on a control signal output from the control unit 14 or detection signals output from various sensors. In one embodiment, the D/M_ECU 22 may serve as a “drive force controller” that performs drive control of the front wheels FR and FL and the rear wheels RR and RL individually. The D/M_ECU 22 also outputs signals, such as an accelerator position signal, detected by various sensors to the control unit 14.

A brake actuator 33 (represented as “BK_AC” in FIG. 1) is coupled to the output side of the BK_ECU 23. The brake actuator 33 adjusts the pressure of a brake fluid to be output to a piston in a brake wheel cylinder (not illustrated) or a piston in a brake caliper (not illustrated) included in each of the brakes 7F and 7R provided in the corresponding wheels FR, FL, RR, and RL. Various sensors (not illustrated), such as a brake pedal sensor, a yaw rate sensor, a longitudinal acceleration sensor, and a vehicle velocity sensor, are coupled to the input side of the BK_ECU 23.

The BK_ECU 23 is a component unit or a circuit unit that controls the driving of the brake actuator 33, based on a control signal output from the control unit 14 or detection signals output from various sensors, so as to perform brake control of the vehicle M. The BK_ECU 23 causes the brake actuator 33 to suitably generate a braking force in each of the wheels FR, FL, RR, and RL to perform a control operation, such as forced brake control or yaw rate control, for the vehicle M. The BK_ECU 23 outputs signals indicating the brake operation state, yaw rate, longitudinal acceleration, and velocity of the vehicle M, for example, output from various sensors to the control unit 14.

The BK_ECU 23 also has the following function. In response to receiving a parking brake ON signal, the BK_ECU 23 activates the brakes 7R for the rear wheels RR and RL to cause them to serve as a parking brake system.

Sensors 17 and a wheel speed sensor 18, for example, are coupled to the control unit 14. Examples of the sensors 17 are a locator unit, an in-vehicle radar, a backward image sensor, a light detection and ranging (LiDAR) device, a near infrared sensor, and an output temperature sensor, none of which are illustrated.

The wheel speed sensor 18 receives a pulse signal (wheel speed pulse) generated in proportion to the revolutions per minute (RPM) of each of the wheels FR, FL, RR, and RL of the vehicle M so as to detect the rotational speed of each of the wheels FR, FL, RR, and RL, thereby calculating the velocity of the vehicle M.

The control unit 14 executes driving control of the vehicle M based on various items of information obtained by the camera unit 10 and the sensors 17. Driving control to be executed by the control unit 14 is driving control operations, which are suitably performed for the vehicle M, and includes an output control operation to be performed by the D/M_ECU 22 for the drive motors 32F and 32R, a control operation to be performed by the D/M_ECU 22 for the torque split ratio between the driving wheels, and a brake control operation to be performed by the BK_ECU 23 for each of the wheels FR, FL, RR, and RL.

As illustrated in FIG. 2, the control unit 14 also contains other components, such as a brake state determiner (represented as “BK state determiner” in FIG. 2) 15 and a road surface μ estimator 16.

The brake state determiner 15 is a component unit or a circuit unit that determines the activation states of the brakes 7F and 7R for the wheels FR, FL, RR, and RL and the activation state of the parking brakes 7R, as well as the physical state of the parking brakes 7R, such as the sticking state, based on various items of information obtained by the sensors 17, for example.

For example, the brake state determiner 15 detects or determines the activation state of the parking brakes 7R by detecting an ON signal or an OFF signal of the parking brake operation switch (not illustrated) included in the HMI 31.

The brake state determiner 15 also detects or determines the physical state of the parking brakes 7R, such as a sticking state caused by, for example, the freezing between the friction applying member and the friction applied member of the parking brakes 7R. In one example, the brake state determiner 15 detects or determines the physical state of the parking brakes 7R, such as the sticking state, from the value of the rotation angle of the drive motor 32R, which is obtained in response to a drive control signal output from the D/M_ECU 22 to the drive motor 32R, or from the value of the speed of the rear wheels RR and RL detected by the wheel speed sensor 18.

The road surface μ estimator 16 is a component unit or a circuit unit that estimates the friction coefficient of the road surface (hereinafter called the road surface μ), based on various items of information obtained by the sensors 17, for example.

In one example, the road surface μ estimator 16 estimates the road surface μ by detecting the spinning of the front wheels FR and FL from the value of the rotation angle of the drive motor 32F, which is obtained in response to a drive control signal output from the D/M_ECU 22 to the drive motor 32F, or from the value of the speed of the front wheels FR and FL detected by the wheel speed sensor 18.

To estimate the road surface μ, the road surface μ estimator 16 may also refer to information on the road condition recognized by the image recognition unit 13 and the values detected by sensors, such as the near infrared sensor and the outside temperature sensor, included in the sensors 17.

The road surface μ estimator 16 may determine whether the road surface is dry, wet, snowy, or icy, based on the luminance difference in an image of the road surface captured by the stereo camera 11, for example, and may use the determination result as secondary information to estimate the road surface μ. In this case, if the road surface is dry or wet, the road surface μ is likely to be high. If the road surface is snowy or icy, the road surface μ is likely to be low.

The road surface μ estimator 16 may use the outside temperature as secondary information to estimate the road surface μ. In this case, if the outside temperature is higher than or equal to a predetermined threshold, the road surface μ is likely to be high. If the outside temperature is lower than the predetermined threshold, the road surface μ is likely to be low.

All or some of the components, such as the image recognition unit 13, control unit 14, brake state determiner 15, road surface μ estimator 16, CP_ECU 21, D/M_ECU 22, and BK_ECU 23, are constituted by a processor including hardware.

The processor is configured as in a known processor and includes peripheral devices. For example, the processor includes a central processing unit (CPU), a random access memory (RAM), a read only memory (ROM), a non-volatile memory, and a non-volatile storage, as well as a non-transitory computer readable medium.

Software programs to be executed by the CPU and fixed data, such as data tables, are prestored in the ROM, non-volatile memory, and non-volatile storage. The CPU reads a software program stored in the ROM, for example, loads it into the RAM, and executes it, and the software program suitably refers to various items of data. As a result, the individual functions of the above-described components and units (image recognition unit 13, control unit 14, brake state determiner 15, road surface μ estimator 16, CP_ECU 21, D/M_ECU 22, and BK_ECU 23) are implemented.

The processor may be constituted by a semiconductor chip, such as a field programmable gate array (FPGA). Each of the above-described components and units (image recognition unit 13, control unit 14, brake state determiner 15, road surface μ estimator 16, CP_ECU 21, D/M_ECU 22, and BK_ECU 23) may be constituted by an electronic circuit.

The entirety or part of the software programs may be recorded, as a computer program product, in a portable disc medium, such as a flexible disk, a compact disc—read only memory (CD-ROM), and a digital versatile disc—read only memory (DVD-ROM), or in a non-transitory computer readable medium, such as a card memory, a hard disk drive (HDD), and a SSD (solid state drive).

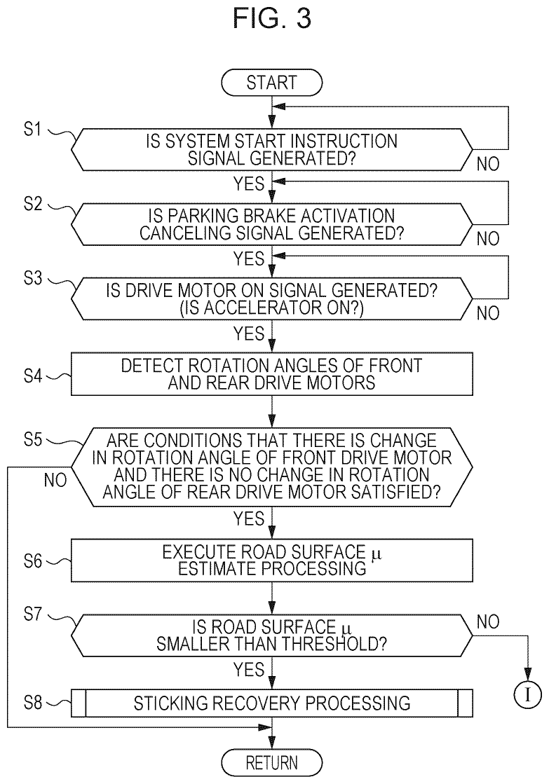

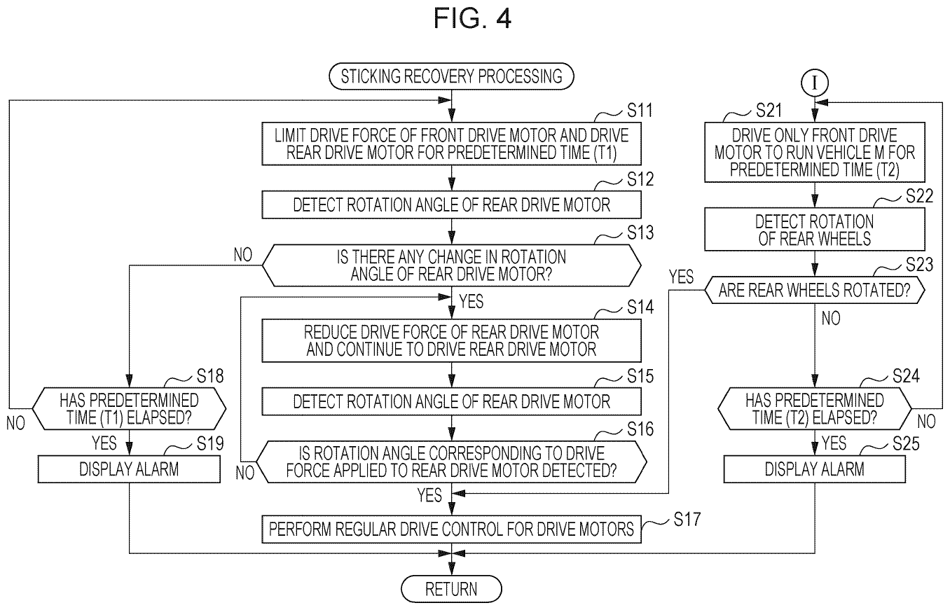

The operation of the vehicle driving control apparatus 1 including the brake control device of the embodiment, and more particularly, a control operation of the vehicle driving control apparatus 1 for the parking brake system, will be described below. FIG. 3 is a flowchart illustrating a control operation of the vehicle driving control apparatus 1 for the parking brake system. FIG. 4 is a flowchart illustrating a subsequence of sticking recovery processing in step S8 in FIG. 3.

It is assumed that the vehicle M is in the parking state and the parking brake system is activated, that is, the parking brakes 7R are applied to the rear wheels RR and RL, and that the system of the vehicle M is OFF.

When the vehicle M is in the above-described state, in step S1 in FIG. 3, the control unit 14 checks whether a start instruction signal for the system of the vehicle M is generated. If a start instruction signal for the system of the vehicle M is found to be generated, the control unit 14 proceeds to step S2. If a start instruction signal for the system of the vehicle M is not generated, the control unit 14 repeats step S1.

Then, in step S2, the control unit 14 checks whether a preset signal for canceling the activation state of the parking brake system (hereinafter will be called a parking brake activation canceling signal) is generated. A parking brake activation canceling signal is generated in the following cases, for example: (1) when a human driver performs a certain operation for canceling the activation of the parking brake system by using the parking brake operation switch; and (2) when a human driver selects and sets a predetermined driving range, such as a D range or an R range, with a select lever and also steps on the accelerator pedal.

If it is determined in step S2 that a parking brake activation canceling signal is generated, the control unit 14 proceeds to step S3. If a parking brake activation canceling signal is not found to be generated, the control unit 14 repeats step S2.

Then, in step S3, the control unit 14 checks whether an instruction signal for driving each of the drive motors 32F and 32R (hereinafter called a drive motor ON signal) is generated. The drive motor ON signal is an instruction signal for driving each of the drive motors 32F and 32R and is a signal for individually controlling the drive motors 32F and 32R. The drive motor ON signal is generated as follows.

First, a human driver steps on the accelerator pedal. Then, the accelerator sensor (not illustrated) detects the step-on operation performed on the accelerator pedal, that is, the accelerator sensor identifies that the accelerator is turned ON. Then, a predetermined instruction signal is generated from the accelerator sensor. The generated instruction signal is output to the D/M_ECU 22. In response to the instruction signal, the D/M_ECU 22 generates a drive motor ON signal.

The D/M_ECU 22 outputs the drive motor ON signal to the front drive motor 32F and the rear drive motor 32R. In response to the drive motor ON signal, the driving of the front drive motor 32F and the rear drive motor 32R is controlled.

If a drive motor ON signal is found to be generated in step S3, the control unit 14 proceeds to step S4. If a drive motor ON signal is not found to be generated, the control unit 14 repeats step S3.

In step S4, the control unit 14 executes parking brake state checking processing for checking the state of the parking brakes. Parking brake state checking processing is, for example, processing for checking whether sticking, for example, is occurring in the parking brake system (brakes 7R for the rear wheels RR and RL) due to freezing, for example.

To execute parking brake state checking processing, the control unit 14 detects the rotation angle of each of the front drive motor 32F and the rear drive motor 32R in step S4.

Then, in step S5, by using the brake state determiner 15, the control unit 14 determines whether sticking, for example, is occurring in the parking brake system, based on the detection result (rotation angle of each of the front drive motor 32R and the rear drive motor 32R) of processing in step S4.

If the detection result of processing in step S4 indicates that, for example, (a) there is a change in the rotation angle of the front drive motor 32F and (b) there is no change in the rotation angle of the rear drive motor 32R, the control unit 14 determines that sticking, for example, is occurring in the brakes 7R for the rear wheels RR and RL and then proceeds to step S6.

In the other cases, for example, if the detection result indicates that (a1) there is a change in the rotation angle of the front drive motor 32F and (b) there is a change in the rotation angle of the rear drive motor 32R, the control unit 14 determines that sticking, for example, is not occurring in the brakes 7R for the rear wheels RR and RL and terminates a series of processing and then returns to a predetermined main sequence.

In this example, it is assumed that sticking, for example, occurs in the parking brake system. It is thus assumed that the situation where there is no change in the rotation angle of the front drive motor 32F would not occur.

In step S6, the control unit 14 executes predetermined road surface μ estimate processing by using the road surface μ estimator 16. The road surface μ estimator 16 estimates the road surface μ in a manner described above.

In step S7, the control unit 14 determines whether the road surface μ estimated in step S6 is smaller than a predetermined threshold. If the road surface μ is found to be smaller than the predetermined threshold, the control unit 14 proceeds to step S8. If the road surface μ is found to be larger than or equal to the predetermined threshold, the control unit proceeds to step S21 in FIG. 4.

In step S8 in FIG. 3, the control unit 14 performs drive control for the drive motor 32R by using the D/M_ECU 22 and executes sticking recovery processing for the parking brake system (brakes 7R for the rear wheels RR and RL).

FIG. 4 is a flowchart illustrating a subsequence for sticking recovery processing in step S8.

After proceeding to step S8 in FIG. 3, in step S11 in FIG. 4, the control unit 14 first causes the D/M_ECU 22 to limit (or to stop) the drive force of the front drive motor 32F and also to start control to drive the rear drive motor 32R with a predetermined drive force for a predetermined time (T1).

Drive control performed by the control unit 14 in step S11 is control processing for clearing the sticking state in the brakes 7R by applying the predetermined drive force mainly to the rear wheels RR and RL for the predetermined time (T1).

As stated above, it has been determined in step S5 that the brakes 7R for the rear wheels RR and RL are in the sticking state. Applying a drive force to the rear wheels RR and RL for a long time imposes an excessive burden on the rear drive motor 32R. Hence, the rear drive motor 32R is driven only for the predetermined time (T1), which is short enough not to produce an adverse influence on the rear drive motor 32R.

The reason why the drive force of the front drive motor 32F is limited (stopped) is as follows. As discussed above, it has been determined in step S7 that the road surface μ is smaller than the predetermined threshold. If the drive force of the front drive motor 32F is applied to the front wheels FR and FL, the vehicle M may start running while the rear wheels RR and RL are locked. Limiting (stopping) the drive force of the front drive motor 32F thus makes it unlikely for the vehicle M to start running.

The elapse of the predetermined time (T1) is measured by the internal clock (not illustrated) of the control unit 14. In step S11, the control unit 14 thus executes certain processing, such as causing the internal clock to start time counting, at the start of drive control processing for the front and rear drive motors 32F and 32R.

During the execution of drive control processing in step S11 for the predetermined time (T1), steps S12 through S18 are executed.

When the execution of step S11 begins, in step S12, the control unit 14 starts to detect the rotation angle of the rear drive motor 32R and continues this operation at preset regular time intervals.

Then, every time the control unit 14 detects the rotation angle of the rear drive motor 32R in step S12, it checks in step S13 whether there is any change in the rotation angle of the rear drive motor 32R. By checking the rotation angle, the control unit 14 can determine whether the brakes 7R for the rear wheels RR and RL have recovered from the sticking state.

If it is determined in step S13 that there is a change in the rotation angle of the rear drive motor 32R, the control unit 14 determines that the brakes 7R are being recovering from the sticking state and proceeds to step S14. If there is no change in the rotation angle of the rear drive motor 32R, the control unit 14 assumes that the brakes 7R have not yet recovered from the sticking state and then proceeds to step S18.

In step S14, the control unit 14 causes the D/M_ECU 22 to reduce the drive force of the rear drive motor 32R and to continue to perform control to drive the rear drive motor 32R.

If it is found in step S13 that there is a change in the rear drive motor 32R, the control unit 14 can determine that the parking brake system is being recovering from the sticking state. When the parking brake system has recovered from the sticking state, the drive force of the rear drive motor 32R is transmitted to the rear wheels RR and RL. At this time, if a certain drive force of the rear drive motor 32R is suddenly transmitted to the rear wheels RR and RL, the vehicle M may start abruptly.

To address this issue, if it is found in step S13 that there is a change in the rotation angle of the rear drive motor 32R, the drive force of the rear drive motor 32R is reduced in step S14. For example, the D/M_ECU 22 performs drive control to gradually attenuate the drive force to be applied to the rear drive motor 32R in accordance with the rotation angle of the rear drive motor 32R.

Alternatively, if it is found in step S13 that there is a change in the rotation angle of the rear drive motor 32R, the D/M_ECU 22 may perform drive control to temporarily stop the application of the drive force to the rear drive motor 32R and then to immediately apply a smaller drive force than the previous time to the rear drive motor 32R.

Then, in step S15, the control unit 14 redetects the rotation angle of the rear drive motor 32R.

Then, in step S16, the control unit 14 checks whether the value of the rotation angle detected in step S15 is equivalent to the rotation angle corresponding to the drive force applied to the rear drive motor 32R. That is, by executing step S16, the control unit 14 can determine whether the drive force of the rear drive motor 32R is smoothly transmitted to the rear wheels RR and RL. If it is determined in step S16 that the value of the rotation angle detected in step S15 is equivalent to the rotation angle corresponding to the drive force applied to the rear drive motor 32R, the control unit 14 proceeds to step S17. If the value of the rotation angle detected in step S15 is not equivalent to the above-described rotation angle, the control unit 14 returns to step S14 and repeats steps S14 through S16.

In step S17, the control unit 14 causes the D/M_ECU 22 to start drive control, which is performed during the regular driving of the vehicle M, to output a drive force to each of the front drive motor 32F and the rear drive motor 32R in accordance with the regular split ratio of the drive force and accelerator position. This enables the vehicle M to drive under regular driving control. The control unit 14 completes a series of processing and returns to the predetermined main sequence.

If it is found in step S13 that the brakes 7R have not yet recovered from the sticking state, the control unit 14 proceeds to step S18. In step S18, the control unit 14 checks whether the predetermined time (T1) has elapsed. If it is found in step S18 that the predetermined time (T1) has elapsed, the control unit 14 proceeds to step S19. If the predetermined time (T1) has not elapsed, the control unit 14 returns to step S11 and repeats the subsequent steps.

In step S19, the control unit 14 causes the CP_ECU 21 to control a notifying device 31a included in the HMI 31 to display a certain notification, such as an alarm. For example, the control unit 14 causes a notifying device 31a to display an alarm to inform an occupant in the vehicle M that the parking brake system is in the sticking state. Additionally, the measures to clear the sticking state of the parking brake system and the procedure thereof may be displayed. The control unit 14 completes a series of processing and returns to the predetermined main sequence.

If the road surface μ is found to be larger than or equal to the predetermined threshold in step S7 in FIG. 3, the control unit 14 proceeds to step S21 in FIG. 4. In step S21, the control unit 14 causes the D/M_ECU 22 to perform control to drive only the front drive motor 32F to run the vehicle M for a predetermined time (T2).

Since the road surface μ is larger than or equal to the predetermined threshold, the reaction force from the road surface is high. A drive force is thus applied to the front wheels FR and FL for the predetermined time (T2) to run the vehicle M by a predetermined distance. This starts to rotate the rear wheels RR and RL before the drive force exceeds the static friction force. With this control operation, the parking brakes 7R can recover from the sticking state.

During the execution of drive control processing in step S21 for the predetermined time (T2), steps S22 through S24 are executed.

When the execution of step S21 begins, in step S22, the control unit 14 starts to detect the rotation of the rear wheels RR and RL and continues this operation at preset regular time intervals.

Then, every time the control unit 14 executes step S22, it checks whether the rear wheels RR and RL are rotated in step S23. By checking the rotation of the rear wheels RR and RL, the control unit 14 can determine whether the brakes 7R for the rear wheels RR and RL have recovered from the sticking state.

If it is determined in step S23 that the rear wheels RR and RL are rotated, the control unit 14 determines that the brakes 7R have recovered from the sticking state and proceeds to step S17.

If the rear wheels RR and RL are not found to be rotated, the control unit 14 assumes that the brakes 7R have not yet recovered from the sticking state and then proceeds to step S24.

In step S24, the control unit 14 checks whether the predetermined time (T2) has elapsed. If it is found in step S24 that the predetermined time (T2) has elapsed, the control unit 14 proceeds to step S25. If the predetermined time (T2) has not elapsed, the control unit 14 returns to step S21 and repeats the subsequent steps.

In step S25, the control unit 14 causes the CP_ECU 21 to control a notifying device 31a included in the HMI 31 to display a certain notification, such as an alarm. The control unit 14 performs control to display a notification in a manner similar to step S19. The control unit 14 then completes a series of processing and returns to the predetermined main sequence.

As described above, according to the above-described embodiment, a brake control device for a vehicle, such as an automobile, includes a drive force controller (D/M_ECU 22), a parking brake system (brakes 7R), and a control unit 14. The drive force controller (D/M_ECU 22) performs drive control of front wheels FR and FL and rear wheels RR and RL individually. The parking brake system (brakes 7R) maintains a parking/stopping state of the vehicle. The control unit 14 at least includes a brake state determiner 15 and a road surface μ estimator 16. The brake state determiner 15 determines the state of the parking brake system. The road surface μ estimator 16 estimates a friction coefficient of the road surface (road surface μ). Based on the determination result of the brake state determiner 15 and the estimation result of the road surface μ estimator 16, the control unit 14 causes the drive force controller (D/M_ECU 22) to perform drive control of the front wheels FR and FL and the rear wheels RR and RL individually.

It is now assumed that the control unit 14 has determined that the parking brake system is in a sticking state. In this case, when the estimated friction coefficient of the road surface (road surface μ) is smaller than a predetermined threshold, the drive force controller (D/M_ECU 22) performs drive control to limit the driving of the front wheels FR and FL and to drive the rear wheels RR and RL. When the estimated friction coefficient of the road surface (road surface μ) is larger than or equal to the predetermined threshold, the drive force controller (D/M_ECU 22) performs drive control to drive only the front wheels FR and FL.

In this manner, when the parking brake system is stuck due to the freezing, for example, the brake control device of the embodiment can automatically detect the sticking state of the parking brake system and automatically execute control to clear this sticking state. The brake system can thus recover from the sticking state.

As a result of the brake control device of the embodiment performing the above-described drive control, it is less likely that an excessive load is imposed on the rear drive motor 32R. Additionally, when the road surface μ is low, the driving of the front drive motor 32F is limited, so that the vehicle M does not start to run. This enables the vehicle M to drive stably.

After the drive force controller (D/M_ECU 22) starts to perform drive control of the front wheels FR and FL and the rear wheels RR and RL, the control unit 14 causes the brake state determiner 15 to redetermine the state of the parking brake system. If it is determined that the parking brake system has recovered from the sticking state, the control unit 14 causes the drive force controller (D/M_ECU 22) to perform control to gradually attenuate a drive force to be applied to the rear wheels RR and RL.

When a drive force is suddenly transmitted to the rear wheels RR and RL after the sticking state is cleared, the vehicle M may start abruptly. As a result of performing the above-described drive control, the vehicle M is less likely to start abruptly and can drive stably.

The brake control device of the embodiment also includes notifying devices 31a. When the redetermination result of the brake state determiner 15 indicates that the parking brake system is still in the sticking state, the control unit 14 causes a notifying device 31a to provide a certain alarm.

As a result of performing the above-described drive control, even if the parking brake system has failed to recover from a sticking state with sticking recovery processing, a certain alarm can be displayed for a driver driving the vehicle M. The driver can thus recognize from the content of the alarm that a failure is occurring in the vehicle M and speedily take measures against this failure.

The brake state determiner 15 detects a change in the rotation angle of the rear drive motor 32R which drives the rear wheels RR and RL. Based on information obtained from the detected change in the rotation angle, the brake system determiner 15 can determine the state of the parking brake system easily and highly accurately.

The disclosure is not limited to the above-described embodiment and various modifications, variations, and applications may be made without departing from the spirit and scope of the disclosure. For example, some of the components disclosed in the embodiment may be omitted suitably, and components in different embodiments may be combined suitably. It is intended that the scope of the disclosure be restricted by the following claims and their equivalents but not by specific embodiments.

For example, in the above-described embodiment, as one mode of a parking brake system, the configuration of an electric parking brake system is illustrated as an example. However, the disclosure is not limited to this mode. As another mode, a mechanical parking brake system using a traction wire, for example, may be used, and a vehicle equipped with this mechanical parking brake system may be applicable to the disclosure in a similar manner.

Additionally, in the above-described embodiment, as a mode of the vehicle M loading the vehicle driving control apparatus 1 including the brake control device of an embodiment of the disclosure, a battery electric vehicle (BEV) using multiple drive motors 32F and 32R as drive sources is used as an example. Nonetheless, the mode of a vehicle using the brake control device of an embodiment of the disclosure is not limited to the configuration discussed in the embodiment. For example, the disclosure is suitably applicable to an existing type of automobile using only an internal combustion engine as a drive source with a fossil fuel, such as gasoline, as well as a hybrid electric vehicle (HEV) and a plug-in hybrid electric vehicle (PHEV) each including an internal combustion engine and an electric motor as drive sources, and a fuel cell electric vehicle (FCEV).

According to an embodiment of the disclosure, it is possible to provide a brake control device for a vehicle, which can perform control to enable a parking brake system for the vehicle to easily recover from a sticking state caused by the freezing, for example, while regulating an excessive burden on a drive source of the vehicle and also to secure the stable driving of the vehicle.

The vehicle driving control apparatus 1 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the vehicle driving control apparatus 1 including the image recognition unit 13, control unit 14, brake state determiner 15, road surface μ estimator 16, CP_ECU 21, D/M_ECU 22, and BK_ECU 23. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A brake control device for a vehicle, the brake control device comprising:
a drive force controller configured to perform drive control of front wheels and rear wheels of the vehicle individually;
a parking brake system configured to maintain a parking/stopping state of the vehicle; and
a control unit at least comprising
a parking brake state determiner configured to determine a state of the parking brake system, and
a road surface μ estimator configured to estimate a friction coefficient of a road surface,
wherein the control unit is configured to cause the drive force controller to perform drive control of the front wheels and the rear wheels individually based on a determination result of the parking brake state determiner and an estimation result of the road surface μ estimator, and
wherein the drive force controller is configured to, when the control unit has determined that the parking brake system is in a sticking state,
perform drive control to limit driving of the front wheels and to drive the rear wheels when the estimated friction coefficient of the road surface is smaller than a predetermined threshold, and
perform drive control to drive only the front wheels when the estimated friction coefficient of the road surface is larger than or equal to the predetermined threshold.

2. The brake control device according to claim 1, wherein the drive force controller is configured to limit the driving of the front wheels by stopping a drive force to be applied to the front wheels when the control unit has determined that the parking brake system is in the sticking state and the estimated friction coefficient of the road surface is smaller than the predetermined threshold.

3. The brake control device according to claim 1, wherein:
the control unit is configured to cause the parking brake state determiner to redetermine the state of the parking brake system after the drive force controller starts to perform drive control of the front wheels and the rear wheels; and
the control unit is configured to cause the drive force controller to perform control to gradually attenuate a drive force to be applied to the rear wheels when the control unit has determined that the parking brake system has recovered from the sticking state.

4. The brake control device according to claim 3, further comprising:
a notifying device,
wherein the control unit is configured to cause the notifying device to provide a preset notification when a redetermination result of the parking brake state determiner indicates that the parking brake system is in the sticking state.

5. The brake control device according to claim 1, wherein the parking brake state determiner is configured to detect a change in a rotation angle of a drive motor which drives the rear wheels.

6. A brake control device for a vehicle, the brake control device comprising:
a parking brake system configured to maintain a parking/stopping state of the vehicle; and
circuitry configured to
perform drive control of front wheels and rear wheels of the vehicle individually,
determine a state of the parking brake system, and
estimate a friction coefficient of a road surface,
wherein the circuitry is configured to perform drive control of the front wheels and the rear wheels individually based on the determined state of the parking brake system and the estimated friction coefficient of the road surface,
wherein the circuitry is configured to, when determining that the parking brake system is in a sticking state,
perform drive control to limit driving of the front wheels and to drive the rear wheels when the estimated friction coefficient of the road surface is smaller than a predetermined threshold, and
perform drive control to drive only the front wheels when the estimated friction coefficient of the road surface is larger than or equal to the predetermined threshold.
